(19) United States
(12) Patent Application Publication
(10) Pub. No.: US 2013/0256951 A1
(43) Pub. Date: Oct. 3, 2013

(54) Shaping tool for producing a substantially shell-shaped, fiber-reinforced plastic part

(71) Applicant: MBB FERTIGUNGSTECHNIK GMBH, Beelen (DE)

(72) Inventors: Robert Buehlmeyer, Herzebrock-Clarholz (DE); Cornelia Kukla, Ahlen (DE)

(73) Assignee: MBB Fertigungstechnik GmbH, Beelen (DE)

(21) Appl. No.: 13/851,304

(22) Filed: Mar. 27, 2013

(30) Foreign Application Priority Data
Mar. 27, 2012 (DE) 102012006038.6

(51) Int. Cl. B29C 43/18

(52) U.S. Cl. CPC B29C 43/18
USPC 264/320; 425/343

(57) ABSTRACT

A shaping tool is constructed for producing a substantially shell-shaped, fiber-reinforced plastic part. The shaping toll includes and upper die and a lower die. A material blank made substantially of fibrous material is placed into the lower die the shaping tool brought into shaping engagement with the material blank. At least one of the dies is segmented into shaping segments for being brought into shaping engagement with the material blank in segments or in groups of segments.

### CROSS-REFERENCE TO A RELATED APPLICATION

The invention described and claimed hereinbelow is also described in German Patent Application DE 10 2012 006038.6, filed on Mar. 27, 2012. This German Patent Application, subject matter of which is incorporated herein by reference, provides the basis for a claim of priority of invention under 35 U.S.C. 119(a)-(d).

### BACKGROUND OF THE INVENTION

The invention relates to a shaping tool for producing a substantially shell-shaped, fiber-reinforced plastic part and to a method for producing such a plastic part.

Shell-shaped, fiber-reinforced plastic parts of the type in question are found in numerous technical fields of use. The field of structural parts of motor vehicles is one example to mention here. Shell-shaped, fiber-reinforced plastic parts are required, for example, for columns, supports, crash elements, seats, or the like. Given that the designs of these structural parts continue to increase in complexity, the limits of the known shaping production methods are being reached to an increasing extent. This particularly applies in the automotive industry where efficient automated production is so important in view of the large numbers of parts involved (manufactured).

EP 1 301 322 B1 discloses a shaping tool comprising an upper die and a lower die, into which a material blank having a fiber mat is placed. The material blank is captively held by a clamping frame, which surrounds the lower die. After insertion of the material blank, a reactive matrix resin is sprayed over the entire surface of the material blank, thereby impregnating the material blank with the matrix resin. Finally, the shaping tool is closed in order to form the material blank.

A problem associated with the known shaping tool is the fact that only relatively flat surface designs of plastic parts can be produced. The problem of folds forming always occurs, in particular, in the case of surface geometries having steep slopes and/or great height differences, since the material blank behaves like a textile-like blank, depending on the composition.

DE 198 29 352 A1 discloses a shaping tool by which a material blank covered with a substantially air-tight film is pressed or drawn into a die by means of compressed air. Pressure is thereby applied to the material blank in a substantially uniform manner, even In the region of slopes in the surface of the plastic part to be produced. However, the design freedom is limited, in particular, by the need for the substantially air-tight film. Furthermore, the time and effort to implement the design and operate the shaping tool are considerable.

### SUMMARY OF THE INVENTION

The present invention overcomes the shortcomings of known arts, such as those mentioned above.

In an embodiment, the invention provides a shaping tool simply constructed to produce fiber-reinforced plastic parts having complicated surface geometries including steep slopes and/or great height differences.

An important feature of the invention is found in segmenting the shaping tool into shaping segments and bringing the shaping tool into shaping engagement with the material blank in segments or in groups of segments. This means that at least a first shaping process takes place in at least two steps, namely in segments or in groups of segments.

The material blank can be locally shaped in a predetermined sequence via the segmenting of the shaping tool. The segments are each assigned to a surface region of the plastic part to be produced and determine the surface geometry of this surface region. By means of this type of segmentation, given an appropriate configuration, a specific shaping engagement with the material blank can be achieved. This makes it possible to counteract fold formation(s) in the material blank in diverse ways.

In an embodiment, the engagement region between the shaping tool and the material blank expands to an edge of the material blank in segments or in groups of segments over the course of the shaping process. This basically corresponds to a “smoothing” of the material blank toward the edge thereof, even though a stroking motion does not necessarily take place along the surface of the material blank.

Experimentation has verified that the above-described, sequentially implemented engagement of the shaping segments with the material blank effectively prevents the formation of folds even given complicated surface geometries of the plastic part. Smoothing, defined in the narrower sense of using a stroking motion along the surface of the material blank, is not necessarily required to obtain a good shaping result.

In an embodiment, the sequentially implemented engagement of the shaping segments with the material blank includes that the segments are resiliently disposed on the carrier part. During the shaping process, the shaping engagement takes place in segments or in groups of segments, which is associated with an inward spring deflection of the corresponding segments. In turn, the inward spring deflection causes a particular subsequent segment or a particular subsequent group of segments to engage with the material blank. The sequentially implemented, shaping engagement of the segments with the material blank is thereby achieved in a feasibly simple manner.

In an embodiment, the shaping process has two steps. In a first step, pre-shaping takes place during the inward spring deflection of the segments. Once the segments have reached a stop, final shaping takes place using an engagement force that is relatively greater than the spring force acting on the segments during pre-shaping.

In a method embodiment, a material blank Is first placed info a shaping tool as described above. After the material blank is inserted, the shaping tool is brought into shaping engagement with the material blank. The material blank is made substantially of fibrous material. The shaping tool is brought into shaping engagement with the material blank in segments or in groups of segments.

### BRIEF DESCRIPTION OF THE DRAWINGS

Further features and advantages of the invention will become apparent from the description of embodiments that follows, with reference to the attached figures, wherein:

FIG. 1a presents a vertical sectional view of an embodiment of a shaping tool of the invention with the material blank inserted, before shaping engagement with the material blank;

FIG. 1b presents a vertical sectional view of the shaping tool with the material blank during pre-shaping;

FIG. 1c presents a vertical sectional view of the shaping tool with the material blank during final shaping;

FIG. 2 presents an upper die of the shaping tool according to FIG. 1a;

FIG. 3a presents a vertical sectional view of an alternative embodiment of the inventive shaping tool during pre-shaping; and

FIG. 3b presents a vertical sectional view of the shaping tool depicted in FIG. 3a during final shaping.

### DETAILED DESCRIPTION OF THE PREFERRED EMBODIMENTS

The following is a detailed description of example embodiments of the invention depicted In the accompanying drawing. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

The figures depict the shaping tools constructed to carry out the proposed method for producing a substantially shell-shaped, fiber-reinforced plastic part 1. An unlimited number of designs for the fiber-reinforced plastic part 1 are feasible through use of the inventive shaping tool.

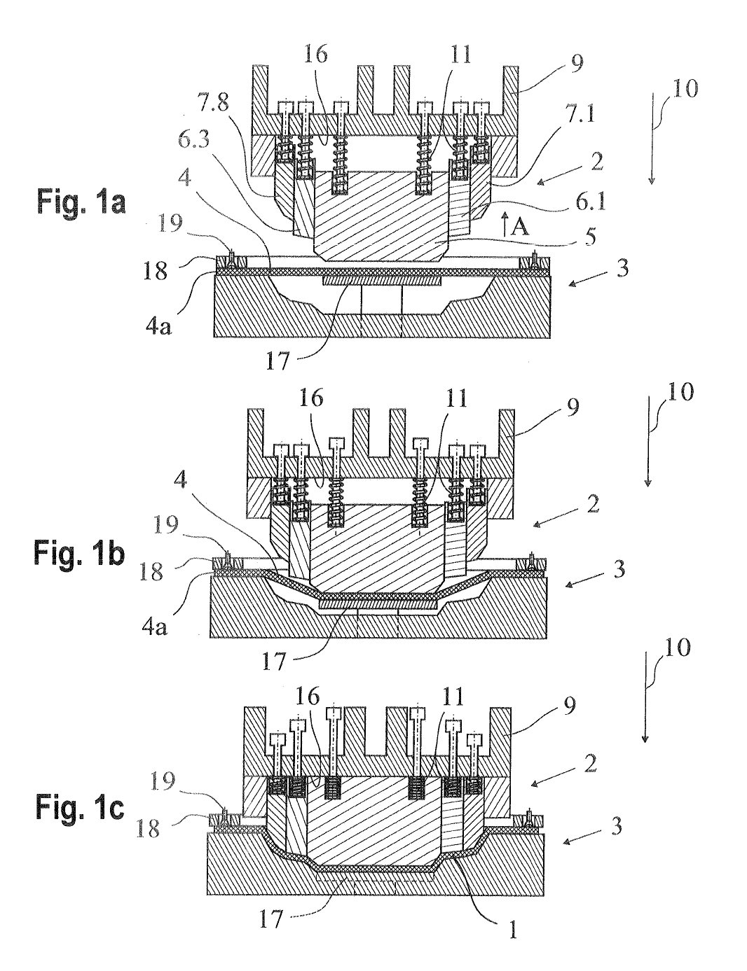

The shaping tool is equipped with an upper die 2 and a lower die 3, wherein a material blank 4 can be placed into the shaping tool and the shaping tool then brought into shaping engagement with the material blank 4. To this end, the shaping tool is configured so as it is closed, the upper die 2 is moved toward the lower die 3. The sequence of steps for forming the material blank 4 is depicted in the sequence of FIGS. 1a, 1b and 1c.

The material blank 4 is substantially a fibrous material In this case. The fibrous material can be any type of fibrous material, preferably a CFRP mat or a CRP mat. In an embodiment, the material blank is a fibrous material impregnated with a matrix material, i.e. a prepreg material. In that case, the prepreg material is preferably a CRP-fabric prepreg material. Basically, the prepreg material can be any type of duroplastic or thermoplastic prepreg material, or a dry fibrous scrim or fabric having a thermoplastic binder portion, depending on the application, without deviating from the scope and spirit of the invention.

The shaping tool produces a plastic part 1, which, in a subsequent method step, is compressed using a compression tool and is cured via the effect of heat. The plastic part 1, which has been produced using the proposed shaping tool, is then a so-called “preform”.

It also is feasible for the proposed shaping tool itself to be used for the compression and, optionally, for the cooling of the plastic part 1. The embodiments depicted in this respect relate to the production of a preform, but are presented for exemplary purposes only and should not be interpreted as limiting the scope of the invention.

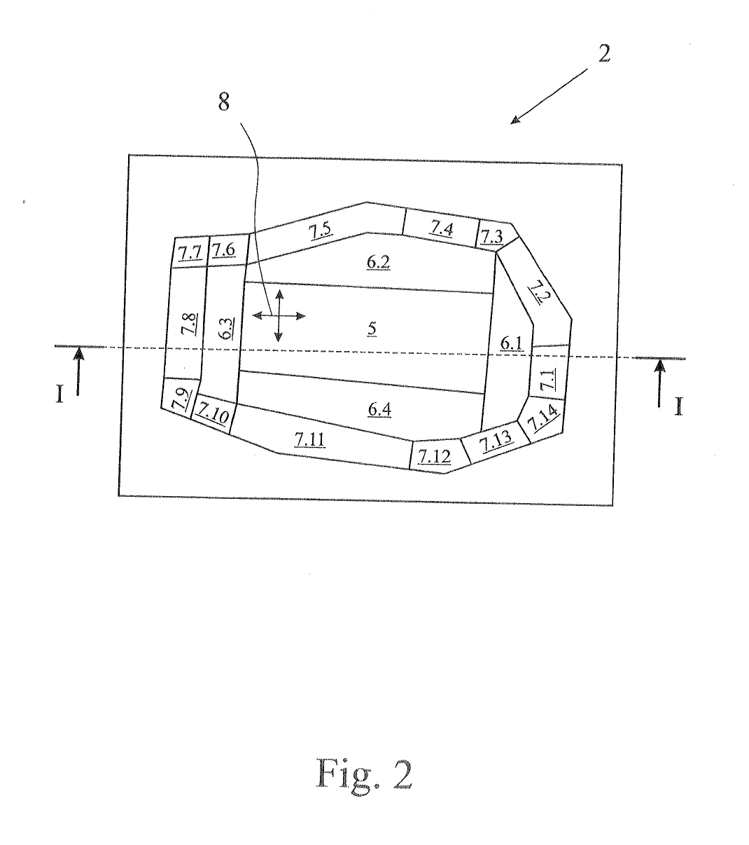

The shaping tool, namely the upper die 2 of the shaping tool, is segmented into shaping segments 5-7. FIG. 2 depicts the segments 5-7 grouped into a total of three segment conglomerates. The first conglomerate comprises the one central segment 5, which is disposed in the middle relative to the other segments 6, 7. The second conglomerate is formed by the segments 6.1, 6.2, 6.3 and 6.4, which are distributed around the central segment 5. Finally, the segments 7.1-7.14 are disposed on the outside. In this case and preferably, the upper die 2 of the proposed shaping tool comprises a total of nineteen individual forming segments.

In the shaping tool, the upper die 2 is configured to be brought into shaping engagement with the material blank 4 in segments. It is also possible for the shaping engagement to be carried out in groups of segments 5-7.

By means of the proposed shaping tool, it is possible to implement specific, shaping engagement of the individual segments 5-7 with the material blank 4. in an embodiment, this shaping engagement is controlled such that the engagement region between the shaping tool and the material blank expands toward an edge 4a of the material blank 4 in segments, possibly also in groups of segments 5-7, over the course of the shaping process. FIG. 2 shows segments 5-7 whereby the first the central segment 5, and then the segments 6.1-6.4 and, finally, the segments 7.1-7.14 enter into shaping engagement with the material blank 4. This sequential implementation of the engagement of the segments 5-7 with the material blank 4 results in the aforementioned smoothing effect for the material blank 4. The direction of the smoothing from the inside toward the outside, i.e., from the central segment 5 toward the particular edges 4a of the material blank 4, is indicated by reference sign 8 in FIG. 2.

The smoothing effect is advantageous for a material blank 4 comprising a prepreg material. Such prepreg materials have a certain viscosity. If folds form, the viscosity can result in very considerable superficial flaws. It has been found that the shaping tool so configured provides a particularly pronounced smoothing effect with prepreg materials, in order to support this effect and, in particular, to improve the Formability of the material blank 4, the material blank is preferably heated before being Placed into the shaping tool.

FIG. 2 shows that the segments 5-7 adjoin one another directly and, in combination, form a die 2, which is the upper die 2 in this case, of the shaping tool. The counter die 3 is the lower die 3, which is designed without segments to ensure a simple structural design. Alternatively or additionally, it is also feasible for the lower die 3 to be segmented.

Basically, it can suffice for the aforementioned expansion of the engagement region to take place in only one direction in order to achieve the smoothing effect. In this case, smoothing is carried out to all edges of the material blank 4. Therefore, in a top view of the corresponding shaping surface of the shaping tool, i.e. the shaping surface of the upper die 2 in this case, at least a portion of the shaping segments 5-7 is arranged in rings. Each of the rings basically extends along the edge 4a of the material blank 4.

FIG. 2 depicts the central shaping segment 5 enclosed by a first ring, which is formed by the segments 6.1-6.4. This first ring is enclosed by another ring, which is formed by the shaping segments 7.1-7.14. The segments of an inner ring and then the segments of an outer ring enter into shaping engagement with the material blank 4 in order to achieve the desired smoothing effect. The shape of the individual rings does not matter, of course.

FIGS. 1a, 1b, 1c together show one form of the structural features by which the sequential engagement of the shaping segments 5-7 can be implemented. An essential point is that the shaping tool comprises at least one carrier part 9 that can be moved toward the inserted material blank 4, and on which said carrier part the segments 5-7 are disposed.

Segments 5-7 are displaceable relative to the carrier part 9 using individual actuators. In an embodiment, segments 5-7 are displaced relative to the carrier part 9 against spring force, for example, along the advancing direction 10, more particularly counter to the advancing direction 10, with respect to the carrier part 9. In this case, at least one spring assembly is assigned to each individual segment 5-7. The spring assembly is indicated using reference sign “11” in FIGS. 1a-c for two segments 5, 6.1, for example.

One segment 5-7 or a group of segments enters into engagement with the material blank 4 as the carrier part 9 is moved toward the material blank 4 and thereby deflects inwardly. The inward spring deflection brings a particular subsequent segment 5-7 or a particular subsequent group of segments 5-7 into engagement with the material blank 4. In view of the upper die 2 depicted in FIG. 2, this means that the central shaping segment 5 enters into engagement with the material blank 4 upon an initial advancement of the carrier part 9 in the advancing direction 10 (FIG. 1b)).

As the carrier part 9 advances further, a sufficient counterforce acts via the material blank 4 counter to the advancing direction. The counterforce thereby deflects the central shaping segment 5 inwardly and engages a subsequent shaping segment 5-7 (which is the shaping segment 6.3 in this case), with the material blank 4. After further advancement of the carrier part 9, accompanied by the inward deflection of the central shaping segment 5 and, now, the shaping segment 6.3, the next shaping segment 6.1 engages with the material blank 4. As advancement of the carrier part 9 continues, the remaining segments 5-7 successively enter into engagement with the material blank 4, thereby resulting, overall, in the aforementioned smoothing effect without the need for complex control measures. Overall, the smoothing effect results simply via the successive inward deflection of the individual segments 5-7.

In FIGS. 1a, 1b, 1c, a different spring preload of the individual segments 5-7 can be selected, thereby optionally resulting in locally different engagement forces. This can also counteract a formation of folds in the material blank 4, given an appropriate Design.

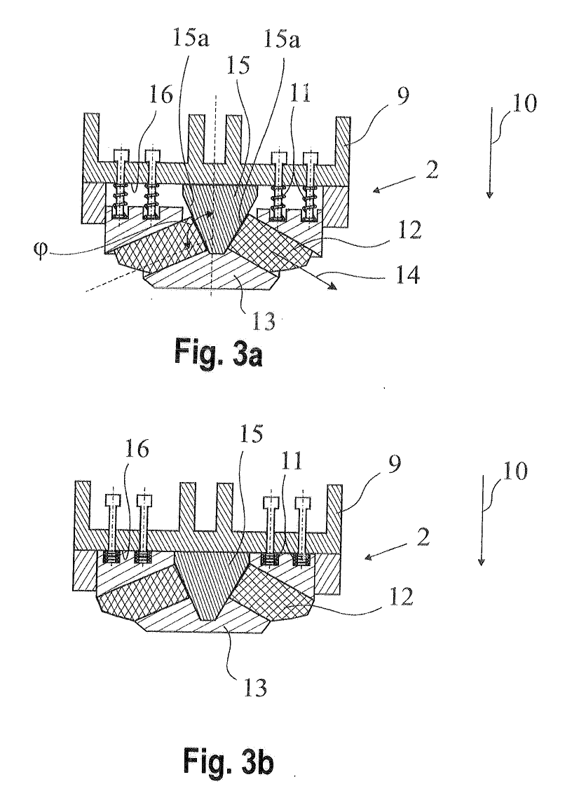

In FIGS. 1a, 1b, 1c and 2, segments 5-7 are deflected inwardly along the advancing direction 10. Alternatively or additionally, however, at least one shaping segment 12 can be deflected inwardly relative to the carrier part 9 at an angle 9 with respect to the advancing direction. This exemplary embodiment is depicted in FIGS. 3a and 3b. As shown, the angle φ moves in a range of approximately 95° to approximately 170°.

The central shaping segment 13 is displaced along the advancing direction 10 in a resilient manner. A shaping segment 12 is provided in the central shaping segment 13, which is displaced at an angle relative to the advancing direction 10 and which is referred to here as a “hold-down sliding element”. In the FIGS. 3a and 3b embodiment, the hold-down sliding element 12 is displaced within the central shaping segment 13 along the sliding direction 14. As the central shaping segment 13 deflects inwardly, the hold-down sliding element 12 moves along a steep plane 15a formed by a driver component 15 disposed on the carrier part 9. This results in a simultaneous displacement of the hold-down sliding element in the sliding direction 14 and, with simultaneous engagement with the material blank 4, to an application of force onto the material blank 4 along the surface thereof. This, in the narrower sense, is equivalent to a smoothing of the material blank 4 with a corresponding smoothing motion. Preferably, two hold-down sliding elements 12 are disposed with mirror symmetry relative to a vertical plane. Correspondingly, the driver component 15 is also equipped with two steep planes 15a, each of which interacts with one of the hold-down sliding elements 12.

A combination of shaping segments 13, 14 having different displacement directions can be implemented by the invention. Given an appropriate configuration, it is possible to produce virtually any surface geometry of the plastic part 1 free of folds. In particular, it is also feasible to obtain a surface geometry having undercuts using an aforementioned hold-down sliding element 12.

In the FIGS. 3a-b embodiment shown, the shaping of the material blank 4 during the inward deflection of the segments 5-7 is a “pre-shaping” of the material blank 4 using relatively low engagement forces. This is followed by a final shaping of the material blank 4 using relatively greater engagement forces. To this end, each of the segments 5-7 deflects inwardly against a stop 16 formed, in this case and preferably, by the carrier part 9. It is thereby possible for the material blank 4 to be pre-shaped during the inward deflection and to not undergo final shaping until the material blank 4 reaches the particular stop 16. FIG. 1c depicts the final shaping, in which, in this case and preferably, all segments 5-7 bear against the stop 16.

Depending on the step in the production sequence in which the proposed shaping tool is utilized, it is advantageous to provide a heating device and/or a cooling device for the segments 5-7 in order to heat and/or cool the segments 5-7. Preferably, the heating and/or cooling is carried out in segments or in groups of segments.

While heating can be used to render the material blank 4 flexible or, optionally, to locally cure the material blank 4, the optional local cooling of the segments 5-7 is used to stiffen the material blank 4 and permit easy detachment of the shaped material blank 4 from the shaping surfaces of the shaping tool without chemical activation of the material blank 4. Such stiffening is advantageous, in particular, for the automated handling of the material blank 4 that may have been shaped in the aforementioned manner.

Heating and/or cooling plays an important role, in particular, when the material blank 4 is a prepreg material. In the case of such prepreg materials, the stiffness and the optional local curing can be controlled via targeted heating and/or targeted cooling. In the case of dry fibrous scrims having a thermoplastic portion, targeted heating is used to stabilize the component. In the subsequent process, the dry fibrous scrim is wetted with resin via an RTM process, for example, and is cured.

Alternatively or in addition to the die 2, it is possible for the counter die 3, e.g., the lower die 3, to comprise a heating device and/or a cooling device. The feature permits the lower die 3 to be heated and/or cooled.

The shaping tool depicted in FIGS. 1a-c provides an advantageous characteristic feature in that the material blanks 4 having large surface area may be utilized. In this case, at least one displaceable segment 17, which is referred to here as a “fold holder”, is assigned to the lower die 3. The fold holder 17 is moved toward the material blank 4 and prevents the material blank 4 from sagging due to the force of gravity after the material blank 4 has been placed in the forming tool, in this case, the fold holder is preloaded in the direction of the material blank 4 against a non-illustrated stop. Hence, advancing the upper die 2 toward the material blank 4 initially presses the material blank 4 between a first segment 5 of the upper die 2 and the fold holder 17 (FIG. 1b), and wherein the fold holder 17 deflects inwardly entirely into the lower die 3 as the upper die 2 is advanced further (FIG. 1c). Advantageously, the fold holder 17 ensures that unwanted fold formation does not occur during the engagement of the central segment 5.

The proposed shaping tool guarantees a high level of process stability without the need to make corrections, in particular upon insertion of the material blank 4. Therefore, a handling device 18 is provided for handling the material blank 4. The handling device inserts the material blank 4 into the shaping tool. A simple clamping frame is used in the insertion, on which the material blank 4 is fixed by means of vacuum grippers 19 and which can be displaced for handling.

The clamping frame 18 is used to easily position the material blank 4 in the shaping tool, wherein the positioning takes place between the two dies 2, 3 of the shaping tool. After the material blank 4 has been positioned by means of the handling device 18, the vacuum grippers 19 are deactivated. In this case, the material blank 4 is placed into the shaping tool in a “floating” manner. The term “floating” means that the material blank 4 is freely displaced in the lateral direction, thereby permitting material of the edges 4a of the material blank 4 to move toward the particular current engagement region during the shaping engagement.

According to a further teaching, the inventive method for producing a substantially shell-shaped, fiber-reinforced plastic part 1, and shaping tool used therein, is used within the framework of a multi-step process. In the case of highly complex components, different upper dies 2 (each of which comprising different shaping segments 5-7), are used sequentially while retaining the same lower die 3. And different layers or inserts can be inserted and further shaped with new layers and different upper dies 2 while retaining the same lower die 3.

In the final step, the material blank 4 (which preferably has been cooled), is removed from the lower die 3 and is preferably placed into a curing tool for curing. Preferably, the aforementioned working steps are automated.

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A shaping tool for producing a substantially shell-shaped, fiber-reinforced plastic part (1), comprising
an upper die (2); and
a lower die (3),
wherein the shaping tool is constructed to receive a material blank (4) made substantially of fibrous material and to enter into a shaping engagement with the material blank (4),
wherein at least the upper die (2) is segmented into shaping segments (5-7) that are brought into shaping engagement with the material blank (4) in segments or in groups of segments.

2. The shaping tool according to claim 1, wherein the shaping tool is brought into shaping engagement with at least one part of the material blank (4) in segments or in groups of segments such that the engagement region expands, in segments or in groups of segments, toward an edge (4a) of the material blank (4) over the course of the shaping process.

3. The shaping tool according to claim 1, wherein the segments (5-7) adjoin one another directly and form the upper die (2) and wherein the lower die (3) is unsegmented.

4. The shaping tool according to claim 1, wherein at least a portion of the segments (5-7) is arranged in rings extending along an edge (4a) of the material blank (4) to be shaped.

5. The shaping tool according to claim 1, further comprising at least one carrier part (9) that is moveable toward the material blank (4) to be shaped and on which the segments (5-7) are disposed.

6. The shaping tool according to claim 5, wherein segments (5-7) are displaced relative to the carrier part (9) against a spring force, wherein one or a group of segments (5-7) enters into engagement with the material blank (4) to be shaped as the carrier part (9) is moved toward the material blank (4) and thereby deflects inwardly, and wherein the inward spring deflection brings a particular subsequent segment (5-7) or a particular subsequent group of segments (5-7) into engagement with the material blank (4).

7. The shaping tool according to claim 6, wherein the inward deflection of at least one segment (5-7) takes place along with and counter to the advancing direction (10) and/or at an angle (φ) with respect to the advancing direction (10) in a range between approximately 95° and 130°.

8. The shaping tool according to claim 6, wherein each of the segments (5-7) deflects inwardly against a stop (16), thereby enabling the material blank (4) to be pre-shaped during the inward deflection and to undergo final shaping once the particular stop (16) is reached.

9. The shaping tool according to claim 1, wherein a heating device and/or a cooling device is provided for the segments (5-7), thereby permitting the segments (5-7) to be heated and/or cooled in segments or in groups of segments.

10. The shaping tool according to claim 1, further comprising a heating device and/or a cooling device for the counter die (3) to enable heating/cooling.

11. The shaping tool according to claim 1, wherein the counter die (3) comprises at least one displaceable segment (17) or fold holder that is moved toward the material blank (4) and/or is preloaded in the direction of the material blank (4) so that advancing the die (2) toward the material blank (4) initially presses the material blank (4) between a first shaping segment (5) of the die (2) and the fold holder (17) and in that the fold holder (17) deflects inwardly as the die (2) is advanced further.

12. The shaping tool according to claim 1, further comprising a handling device (18) in a form of a clamping frame that is displaceable for handling and positioning the material blank (4) in the upper and lower dies (2, 3).

13. A method for producing a substantially shell-shaped, fiber-reinforced plastic part (1), comprising:
placing a material blank (4), made substantially of a fibrous material, into a shaping fool comprising an upper die (2) and a lower die (3), and
bringing the shaping tool Into shaping engagement with the material blank (4);
wherein the at least the upper die (2) of the shaping tool is segmented into shaping segments (5-7) and wherein the upper die so configured is brought into shaping engagement with the material blank (4) in segments or in groups of segments.

14. The method according to claim 13, wherein the material blank (4) comprises one of a fibrous material impregnated with a matrix material and a dry fibrous scrim or fabric having a thermoplastic matrix portion.

15. The method according to claim 13, wherein the shaping tool is brought into shaping engagement with at least one part of the material blank (4) in segments or in groups of segments such that the engagement region expands, in segments or in groups of segments, toward an edge (4a) of the material blank (4) over the course of the shaping process.
